(19) United States
(12) Patent Application Publication
(10) Pub. No.: US 2026/0226948 A1
(43) Pub. Date: Aug. 6, 2026

(54) CAM CLUTCH

(71) Applicant: TSUBAKIMOTO CHAIN CO., Osaka (JP)

(72) Inventor: Taketsugu Kawashima, Osaka-shi (JP)

(73) Assignee: TSUBAKIMOTO CHAIN CO., Osaka (JP)

(21) Appl. No.: 19/635,940

(22) Filed: Apr. 1, 2026

Related U.S. Application Data
(63) Continuation of application No. PCT/JP2024/025201, filed on Jul. 12, 2024.

(30) Foreign Application Priority Data
Oct. 2, 2023 (JP) 2023-171347

(51) Int. Cl. F16D 41/07; F16D 41/08; F16D 41/06

(52) U.S. Cl. CPC F16D 41/07; F16D 41/084; F16D 2041/0605

(57) ABSTRACT

An object of the present invention is to provide a cam clutch that allows easy switching of operating modes with a simple structure and a small force. The cam clutch includes a first biasing means (150) that biases plural cams (136) disposed between coaxial and relatively rotatable inner race (110) and outer race (120) to rotate in an engaging direction, and a second biasing means (155) that biases the cams to rotate in a disengaging direction with a different biasing force than that of the first biasing means (150). The above object is achieved by a switching means (170) configured to switch operating modes by changing a larger one of biasing forces applied to the same cam by the first biasing means (150) and the second biasing means (155) to become relatively smaller than the other of the biasing forces.

### DESCRIPTION

### TECHNICAL FIELD

The present invention relates to a cam clutch.

### BACKGROUND ART

Some types of clutches that control transmission and interruption of rotational force are configured with an inner race and an outer race, a plurality of cams as engaging elements disposed between the inner race and the outer race, and biasing means that bias the cams in an engaging direction. Some of these clutches are known to include a switching means configured to change the clutch operating modes, for example, by forcibly tilting the cams.

For example, Patent Literature 1 and Patent Literature 2 describe a configuration in which forward-rotation sprags and reverse-rotation sprags serving as engaging elements are disposed between the inner race and the outer race in a state of being biased in an engaging direction by a biasing means, and are configured to be tiltable in a disengaging direction by axial movement of a switching means.

In these two-way clutches, when torque is input to the inner race or the outer race, one of the forward-rotation sprags and reverse-rotation sprags functions as a wedge and bites into the inner race and the outer race, thereby enabling torque transmission. Moving the switching means in the axial direction tilts both the forward-rotation sprags and the reverse-rotation sprags in the disengaging direction against the biasing force of the biasing means, thereby enabling freewheeling in both forward and reverse directions.

In one-way clutches, too, provision of a switching means enables a free mode that allows relative rotation between the inner race and the outer race in both forward and reverse directions.

### Citation List

### Patent Literature

Patent Literature 1: Japanese Patent Application Publication No. H06-017851

Patent Literature 2: Japanese Patent Application Publication No. 2008-121867

### SUMMARY OF INVENTION

### Technical Problem

In a clutch having a switching means, the sprags are firmly supported by torque received from the inner race and the outer race during torque transmission. Accordingly, tilting the sprags in the disengaging direction by circumferentially pressing the sprags with the switching means requires an extremely large force, and operation of the switching means during torque transmission may result in breakage of the sprags or the switching means.

Specifically, in two-way clutches switchable between driving and freewheeling in both forward and reverse directions, as torque is progressively applied to the inner race or the outer race, the sprags and the inner and outer races each undergo elastic deformation. As a result, a difference in rotational angle (windup) occurs between the inner race and the outer race, and when the load is removed, the windup returns to zero.

During torque transmission, when one of the forward-rotation sprags and the reverse-rotation sprags is engaged with the inner race and the outer race, the other set of sprags stays in sliding contact with the outer race and the inner race, thereby maintaining a standby state for engagement. When the torque is removed, one set of sprags tilts in the disengaging direction to transition to a freewheeling state. However, before the one set of sprags is fully disengaged, there is a risk that the other set of sprags may tilt in the engaging direction and start engaging the inner race and the outer race, thereby causing “jamming” in which all of the sprags are engaged at the same time.

In a two-way clutch such as the one mentioned above, there remains the problem that, when the sprags are jammed due to windup, even if torque is removed by stopping rotation of the inner race or the outer race, pressing the sprags circumferentially to tilt them in the disengaging direction by the switching means requires a large force because all the sprags are engaged with high contact pressure.

An object of the present invention, which has been made based on the circumstances described above, is to provide a cam clutch that allows easy switching of operating modes with a simple structure and a small force.

### Solution to Problem

To achieve the above object, the present invention provides a cam clutch including: an inner race and an outer race coaxially disposed and rotatable relative to each other; a plurality of cams disposed between the inner race and the outer race; a first biasing means that biases the cams to rotate in an engaging direction; and a switching means configured to forcibly rotate the cams to allow switching of operating modes. The cam clutch further includes a second biasing means that biases the cams to rotate in a disengaging direction, with a force that is different from a biasing force applied by the first biasing means. The switching means includes a cam orientation changing part configured to change a larger one of biasing forces applied to the same cam by the first biasing means and the second biasing means to become relatively smaller than the other of the biasing forces.

### Advantageous Effects of Invention

According to the invention set forth in claim 1, the cam clutch is switchable between a lock mode and a free mode, not by directly pressing the cams to tilt them but by changing the balance of biasing forces applied to the same cam between the biasing force of the first biasing means in the engaging direction and the biasing force of the second biasing means in the disengaging direction. The switching of operating modes requires only a magnitude of force that can elastically deform the biasing means, and therefore, the operating modes can be switched with a simple structure and a small force. The operating modes can be switched without stopping the rotation between the inner race and the outer race, so that the switching means can be operated easily even during torque transmission.

According to the invention set forth in claim 2, stable operation can be achieved without variation among the respective rotational motions of the plurality of cams.

According to the invention set forth in claim 3, the respective rotary motions of the first cam and the second cam each having a different engaging direction are linked so that, with a rotation in the engaging direction of one of the first cam and the second cam, the other cam can be rotated in the disengaging direction. Therefore, while one of the cams is engaged with the inner race and the outer race, the other cam can be maintained separated from the inner race or the outer race. Thus unwanted jamming of cams is reliably prevented.

According to the invention set forth in claim 4 to claim 6, changing the biasing force of the first biasing means allows the cams to rotate in the disengaging direction by the biasing force of the second biasing means and to separate from the inner race or the outer race. Thus the switching means can be operated easily with a smaller force.

According to the invention set forth in claim 7, at least one of the first biasing means and the second biasing means is common to the plural cams so that the number of components can be reduced, and variation in the behavior of the cams can be avoided.

According to the invention set forth in claim 8, the cam clutch is switchable between four operating modes by selectively rotating one or both of the first cam and the second cam: A two-way lock mode in which torque is transmissible in both forward and reverse directions; a forward lock mode in which torque is transmissible in the forward direction; a reverse lock mode in which torque is transmissible in the reverse direction; and a two-way free mode in which the clutch freewheels in both forward and reverse directions.

### BRIEF DESCRIPTION OF DRAWINGS

FIG. 1 is an exploded perspective view of a configuration of a cam clutch according to a first embodiment of the present invention.

FIG. 2 is a sectional perspective view of the cam clutch shown in FIG. 1 in an assembled state, taken along a plane including a rotation axis.

FIG. 3 is an exploded perspective view of a cam mechanism configuration.

FIG. 4 is a plan view of the configuration of the cam clutch shown in FIG. 2 as seen from one axial side, with some parts thereof being omitted.

FIG. 5 is a diagram illustrating a cam configuration, (a) being a plan view as seen from one axial side and (b) being a side view.

FIG. 6 is a side view of a state of the cam clutch shown in FIG. 1 after its operating mode has been switched from the two-way free mode to the two-way lock mode.

FIG. 7 is a schematic diagram illustrating a state of the cam clutch shown in FIG. 1 when its operating mode is the two-way free mode.

FIG. 8A is a schematic diagram illustrating a state of the cam clutch shown in FIG. 1 when its operating mode is the two-way lock mode.

FIG. 8B is a schematic diagram illustrating a state of the cam clutch shown in FIG. 1 when its operating mode is the two-way lock mode and the inner race is rotated in a forward direction.

FIG. 9 is a sectional perspective view of a configuration of a cam mechanism in a cam clutch according to a second embodiment of the present invention, taken along a plane including a rotation axis.

FIG. 10A is a plan view of the cam clutch according to the second embodiment of the present invention, schematically illustrating the configuration as seen from one axial side with some parts thereof being omitted, when the operating mode is the two-way lock mode.

FIG. 10B is a schematic plan view of a state of the cam clutch according to the second embodiment of the present invention when its operating mode is the two-way free mode.

FIG. 11 is a perspective view of a second biasing means in a cam clutch according to a third embodiment of the present invention, illustrating its configuration with some cams.

FIG. 12A is a plan view of the cam clutch according to the third embodiment of the present invention, schematically illustrating the configuration as seen from one axial side with some parts thereof being omitted, when the operating mode is the two-way free mode.

FIG. 12B is a schematic plan view of a standby state of the cam clutch according to the third embodiment of the present invention when its operating mode is the two-way lock mode.

FIG. 13 is a partially cutaway perspective view of a cam clutch configuration according to a fourth embodiment of the present invention.

FIG. 14A is a side view of a state of the cam clutch shown in FIG. 13 when its operating mode is the two-way free mode.

FIG. 14B is a schematic plan view of a state of the cam clutch shown in FIG. 13 when its operating mode is the two-way free mode.

FIG. 15A is a side view of a state of the cam clutch shown in FIG. 13 when its operating mode is the forward lock mode.

FIG. 15B is a schematic plan view of a standby state of the cam clutch shown in FIG. 13 when its operating mode is the forward lock mode.

FIG. 16A is a side view of a state of the cam clutch shown in FIG. 13 when its operating mode is the reverse lock mode.

FIG. 16B is a schematic plan view of a standby state of the cam clutch shown in FIG. 13 when its operating mode is the reverse lock mode.

FIG. 17A is a side view of a state of the cam clutch shown in FIG. 13 when its operating mode is the two-way lock mode.

FIG. 17B is a schematic diagram illustrating a standby state of the cam clutch shown in FIG. 13 when its operating mode is the two-way lock mode.

FIG. 18 is a partially cutaway perspective view of a cam clutch configuration according to a fifth embodiment of the present invention.

FIG. 19A is a partial sectional view, taken along a plane including a rotation axis, of a state of the cam clutch shown in FIG. 18 when its operating mode is the lock mode in which torque is transmitted in both directions between the outer race and the first inner race.

FIG. 19B is a partial sectional view, taken along a plane including a rotation axis, of a state of the cam clutch shown in FIG. 18 when its operating mode is the two-way free mode.

FIG. 19C is a partial sectional view, taken along a plane including a rotation axis, of a state of the cam clutch shown in FIG. 18 when its operating mode is the lock mode in which torque is transmittable in both directions between the outer race and the second inner race.

FIG. 20 is a plan view of a schematic illustration of yet another configuration example of the cam clutch according to the present invention, as seen from one axial side.

### DESCRIPTION OF EMBODIMENTS

### First Embodiment

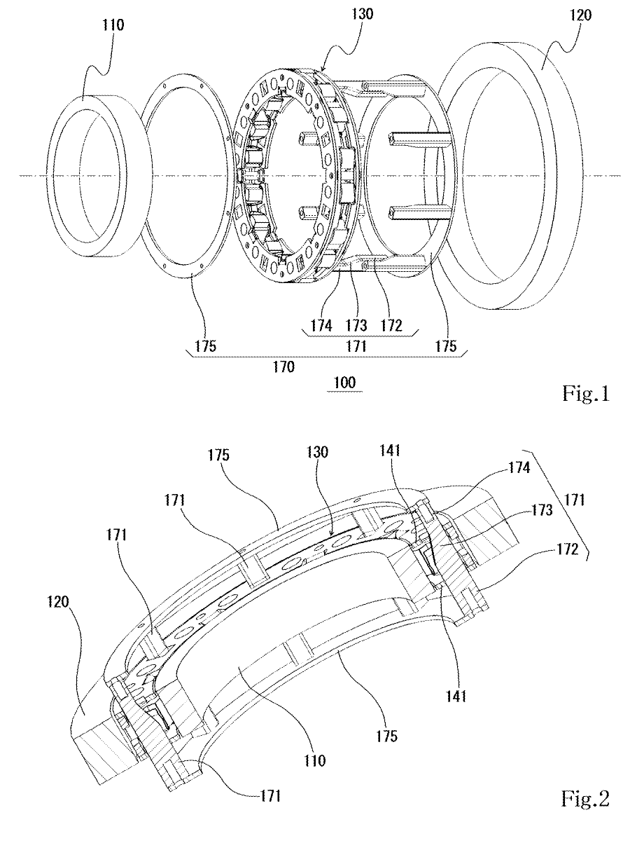

As shown in FIG. 1, a cam clutch 100 according to a first embodiment of the present invention includes an inner race 110 and an outer race 120, a cam mechanism 130 for transmitting and interrupting torque between the inner race 110 and the outer race 120, and a switching means 170 configured to switch operating modes of the cam clutch 100.

As shown in FIG. 2, the inner race 110 and the outer race 120 of the assembled cam clutch 100 are disposed such as to be rotatable relative to each other about the same rotation axis, and the cam mechanism 130 is disposed between the inner race 110 and the outer race 120.

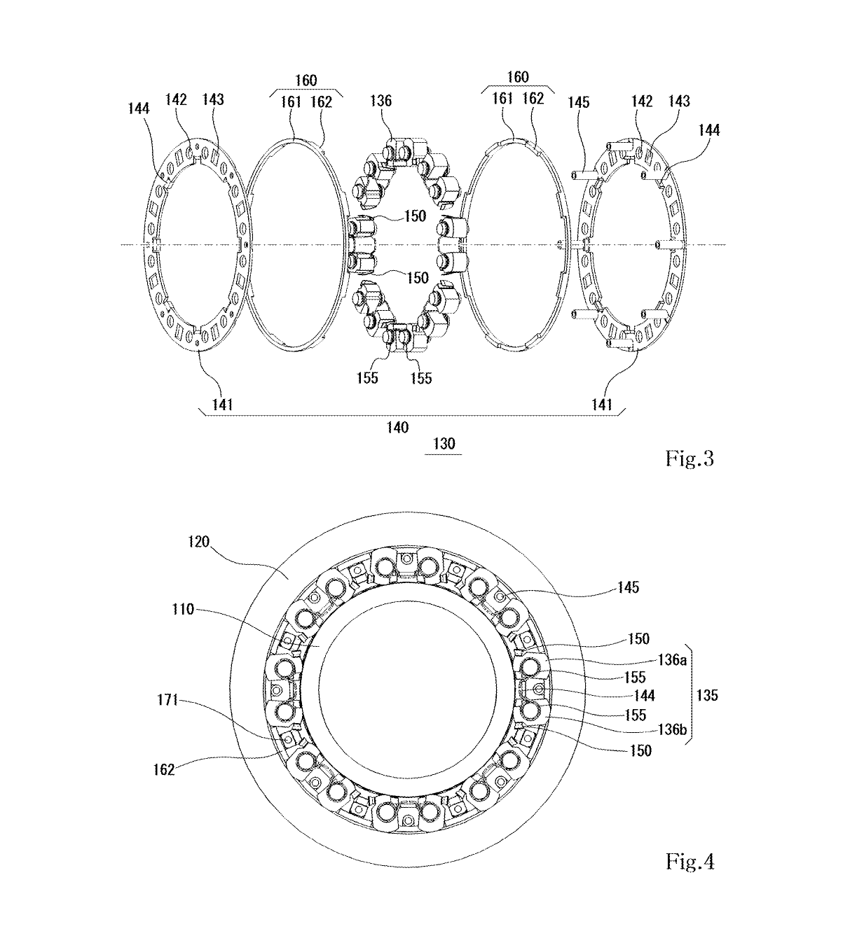

As shown in FIG. 3, the cam mechanism 130 includes a plurality of cams 136, a cage ring 140 that holds each of the plural cams 136, a first biasing means 150 that biases each of the plural cams 136 to rotate in an engaging direction, and a second biasing means 155 that biases each of the plural cams 136 to rotate in a disengaging direction with a force that is different from the force applied by the first biasing means 150.

As shown in FIG. 4, the plurality of cams 136 include a first cam 136a and a second cam 136b that engage in different directions with the inner race 110 and the outer race 120. In this embodiment, the first cam 136a and the second cam 136b adjacent each other form a cam pair, and a plurality of cam pairs 135 are circumferentially arranged at predetermined intervals on the same circumference. The arrangement of the first cams 136a and second cams 136b in the cam mechanism 130 is not limited to a specific layout. By alternately arranging the first cams 136a and the second cams 136b, a common switching means can simultaneously rotate the first cams 136a and the second cams 136b, whereby an increase in the structural complexity and size of the cam clutch 100 can be avoided. The first cams 136a and the second cams 136b need not be arranged alternately on the same circumference. The numbers of the first cams 136a and the second cams 136b may be the same, or different.

The first cam 136a is configured to come into frictional engagement with the inner race 110 and the outer race 120 when the inner race 110 is rotated in the forward direction (clockwise in FIG. 4), or when the outer race 120 is rotated in the reverse direction (counterclockwise in FIG. 4), and to tilt in a direction in which the cam separates from and comes out of contact with the inner race 110 when the inner race 110 is rotated in the reverse direction or when the outer race 120 is rotated in the forward direction.

The second cam 136b is configured to come into frictional engagement with the inner race 110 and the outer race 120 when the inner race 110 is rotated in the reverse direction or when the outer race 120 is rotated in the forward direction, and to tilt in a direction in which the cam separates from and comes out of contact with the inner race 110 when the inner race 110 is rotated in the forward direction or when the outer race 120 is rotated in the reverse direction.

In this embodiment, the first cam 136a and the second cam 136b have an identical outer shape, i.e., the first cam 136a reversed front to back is used as the second cam 136b. Hereinafter, the first cam 136a and the second cam 136b shall be simply referred to as cams 136, except when specifically mentioned separately. The first cam 136a and the second cam 136b may have different outer shapes. Having an identical outer shape, however, can reduce the number of components.

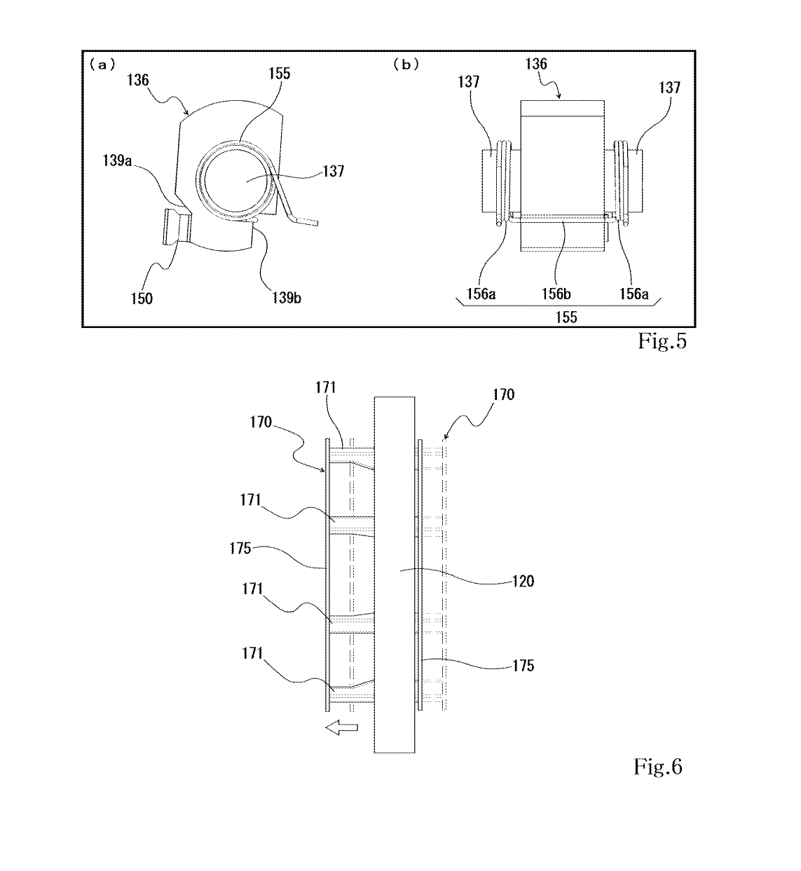

As shown in FIG. 5(a) and (b), the cam 136 in this embodiment has rotating shaft portions 137, each axially protruding outward from either end face that extends along a plane perpendicular to the rotation center.

The cam 136 is formed with a notched portion 139a on a side face continuous with the inner-race engaging surface, on one side relative to the contact point with the inner race 110 in the disengaging direction (clockwise direction in FIG. 5(a)). The side face continuous with the inner-race engaging surface is further formed, on one side relative to the contact point in the engaging direction (counterclockwise direction in FIG. 5(a)), with a stepped portion 139b configured to allow a coupling portion 156b of a torsion spring that forms a second biasing means 155 described later to engage.

As shown in FIG. 3, the cage ring 140 is composed of a pair of annular plate members 141 and rod-like spacer members 145 that couple the annular plate members 141 together with a predetermined axial spacing therebetween.

Each of the annular plate members 141 is formed with retaining holes 142 that rotatably hold the rotating shaft portions 137 of the cams 136, and through holes 143 for cam orientation changing parts 171 of the switching means 170 to pass through.

The spacer members 145 are arranged circumferentially at predetermined intervals on the same circumference to be each positioned between the first cam 136a and the second cam 136b of each of the plural cam pairs 135.

In this embodiment, the first biasing means 150 is a plate spring, and provided to each of the cams 136. Specifically, as also shown in FIG. 5(a), the first biasing means 150 is arranged in the notched portion 139a of the cam 136, with its bent portion being positioned on the other axial side and one tip portion continuous with the bent portion being fixed to the cam 136 as a fixed end. The other tip portion continuous with the bent portion is formed as a movable end that makes contact with a cam orientation changing part 171 of the switching means 170.

The second biasing means 155 is a torsion spring, and provided to each of the cams 136. Specifically, as also shown in FIG. 5(b), the torsion spring includes two spiral coil portions 156a and a straight, axially extending coupling portion 156b that connects opposite ends of the coil portions 156a together. The torsion spring is mounted on the cam 136 with the coil portions 156a fitted on the rotating shaft portions 137 on either axial side and the coupling portion 156b engaging the stepped portion 139b of the cam 136. The other end of each coil portion 156a is supported by a second biasing means support portion 144 formed on the annular plate member 141 of the cage ring 140, as shown in FIG. 4. This configuration prevents contact between the cam 136 and the inner race 110 when the cam 136 is lifted up.

The switching means 170 is provided such as to be movable in the axial direction between a first fixing position and a second fixing position that is closer to one axial end than the first fixing position.

As shown in FIGS. 1 and 2, the switching means 170 is made up of a plurality of axially extending columnar cam orientation changing parts 171 arranged between the inner race 110 and the outer race 120, and a pair of annular plate-like fixing members 175 fixed to either end of each cam orientation changing part 171. The cam orientation changing parts 171 are passed through the through holes 143 of the cage ring 140 such as to be axially movable, each of them being positioned between adjacent cam pairs 135.

The cam orientation changing part 171 has a cross-sectional shape that changes in the axial direction so as to be able to change the biasing force, applied on the same cam 136, of one of the first biasing means 150 and the second biasing means 155 having a larger biasing force than the other to become relatively smaller than the other’s biasing force.

In this embodiment, the cam orientation changing part 171 is configured to change the biasing force of the first biasing means 150 on the cam 136 by axial movement of the switching means 170. More specifically, the cam orientation changing part is configured to change, upon axial movement of the switching means 170 from the first fixing position to the second fixing position closer to one axial end, the first biasing means 150 into a state in which the first biasing means is capable of applying a larger biasing force than a biasing force of the second biasing means 155, or, in other words, to change the biasing force of the second biasing means 155 to become smaller than the biasing force of the first biasing means 150.

The configuration of the cam orientation changing part 171 is described in more specific terms. As shown in FIG. 1 and FIG. 2, the cam orientation changing part 171 includes a prismatic biasing force application portion 172, a biasing force changing portion 173 continuous with one end of the biasing force application portion 172, and a prismatic biasing force release portion 174 continuous with one end of the biasing force changing portion 173 and having a smaller radial dimension than the biasing force application portion 172. The biasing force changing portion 173 is formed such that its radially inner surface extends radially outward at an angle as it extends toward one axial end.

The cam clutch 100 according to this embodiment includes cam link members 160 that rotate the first cams 136a and the second cams 136b of the cam pairs 135 together by transmitting the rotation of one of the first cams 136a and the second cams 136b to the other.

The cam link member 160 includes an annular base part 161 having the same outside diameter as that of the annular plate members 141 of the cage ring 140, as also shown in FIG. 3. The base part 161 is formed with circumferentially extending, and axially protruding, pawl portions 162 at predetermined intervals in the circumferential direction.

The cam link members 160 are fitted over the spacer members 145 from an outer circumferential side, as shown in FIG. 4, with each pawl portion 162 being positioned between adjacent cam pairs 135 so that their radial movement is restricted. The other side of the base part 161 of each cam link member is in contact with the inner face of the annular plate members 141 of the cage ring 140 on either side of the cams 136.

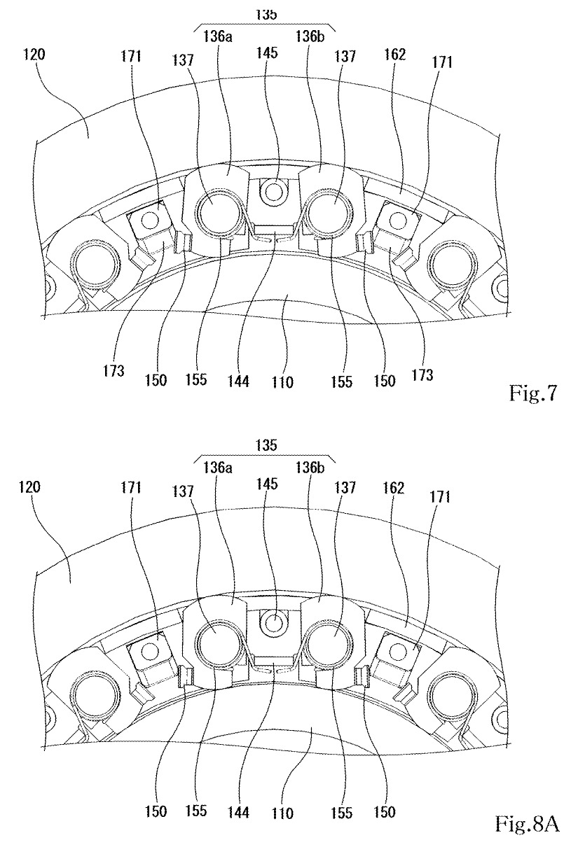

In the cam clutch 100 described above, as indicated with broken lines in FIG. 6, when the switching means 170 is in the first fixing position, the movable end of the first biasing means 150 is in contact with the biasing force changing portion 173 of the cam orientation changing part 171 as shown in FIG. 7, so that the biasing force of the first biasing means 150 is smaller than the biasing force of the second biasing means 155, or the biasing force of the first biasing means 150 is released. Therefore, both the first cam 136a and the second cam 136b are biased to rotate in the disengaging direction, so that both the first cam 136a and the second cam 136b are in a non-contact state separated from the outer circumferential surface of the inner race 110. Thus the operating mode of the cam clutch 100 is the two-way free mode that allows relative rotation between the inner race 110 and the outer race 120 in both forward and reverse directions.

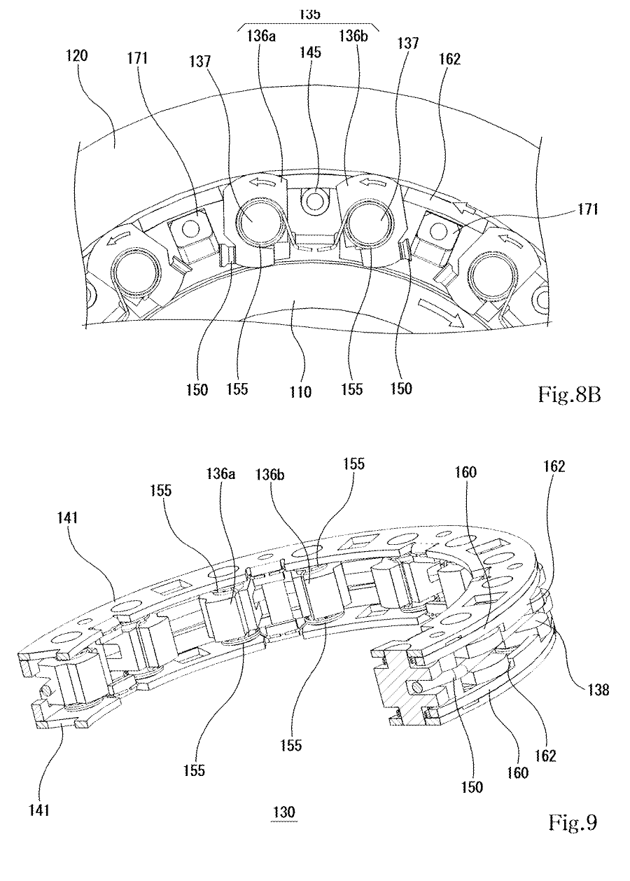

When the switching means 170 is moved from the first fixing position to the second fixing position closer to one axial end as indicated with solid lines in FIG. 6, the cam orientation changing part 171 presses the first biasing means 150 in the compressing direction as shown in FIG. 8A. This causes the biasing force of the first biasing means 150 to become larger than the biasing force of the second biasing means 155 so that the first cam 136a and the second cam 136b are biased to rotate in the engaging direction. Therefore, the first cam 136a and the second cam 136b come into sliding contact with the inner race 110 and the outer race 120, thereby being brought into a standby state in which one of the first cam 136a and the second cam 136b is able to immediately engage the inner race 110 and the outer race 120. Thus the operating mode of the cam clutch 100 is switched to the two-way lock mode that prevents relative rotation between the inner race 110 and the outer race 120 in both forward and reverse directions.

For example, as shown in FIG. 8B, when the inner race 110 is rotated in the forward direction (clockwise in FIG. 8B), the first cam 136a rotates in the engaging direction to come into frictional engagement with the inner race 110 and the outer race 120. As the first cam 136a rotates, it presses the pawl portion 162 of the cam link member 160 in the circumferential direction, so that the cam link member 160 rotates. The pawl portions 162 of the cam link member 160 thus press the second cams 136b to rotate in the disengaging direction. The same happens when the outer race 120 is rotated in the reverse direction (counterclockwise in FIG. 8A).

When the inner race 110 is rotated in the reverse direction, or when the outer race 120 is rotated in the forward direction, the second cams 136b rotate in the engaging direction to come into frictional engagement with the inner race 110 and the outer race 120, which causes the first cams 136a to rotate in the disengaging direction by the action of the cam link member 160.

As described above, the operating mode of the cam clutch 100 is switchable between the two-way free mode and the two-way lock mode, not by directly pressing and rotating the cams 136, but by changing the balance of biasing forces applied to the same cam 136 between the biasing force of the first biasing means 150 in the engaging direction and the biasing force of the second biasing means 155 in the disengaging direction. The switching of operating modes requires only a magnitude of force that can elastically deform the first biasing means 150, and therefore, the operating modes can be switched with a simple structure and a small force. The operating modes can be switched without stopping the rotation between the inner race 110 and outer race 120, so that the switching means 170 can be operated easily even during torque transmission.

When switching from the two-way lock mode to the two-way free mode, in particular, the biasing force of the first biasing means 150 is reduced so that the cams 136 rotate in the disengaging direction by the biasing force of the second biasing means 155 to separate from the inner race 110 or the outer race 120. Thus the switching means 170 can be operated easily with a smaller force.

The rotation of one of the first cam 136a and the second cam 136b in the engaging direction causes the other cam to rotate in the disengaging direction by the action of the cam link member 160. Therefore, when one set of cams is engaging the inner race 110 and the outer race 120, the other set of cams is maintained away from the inner race 110 or the outer race 120. Thus unwanted jamming of cams is reliably prevented.

In the cam clutch 100 according to the first embodiment described above, the first biasing means 150 and the second biasing means 155 are provided to each of the plural cams 136. Instead, the first biasing means 150 may be other elastic members that are able to bias the first cams 136a and the second cams 136b to rotate in the engaging direction, and the second biasing means 155 may be other elastic members that are able to bias the first cams 136a and the second cams 136b to rotate in the disengaging direction. For example, at least one of the first biasing means 150 and the second biasing means 155 may be configured by a component common to the first cams 136a and the second cams 136b.

### Second Embodiment

The cam clutch according to a second embodiment of the present invention has the same configuration as the cam clutch 100 according to the first embodiment except that a common garter spring is used for the first cams 136a and the second cams 136b instead of the plate springs as the first biasing means 150 of the cam clutch 100 according to the first embodiment.

As shown in FIG. 9, the garter spring as the first biasing means 150 is mounted in mounting grooves 138 circumferentially extending on the respective engaging surfaces of the first cams 136a and the second cams 136b on the side facing the outer race.

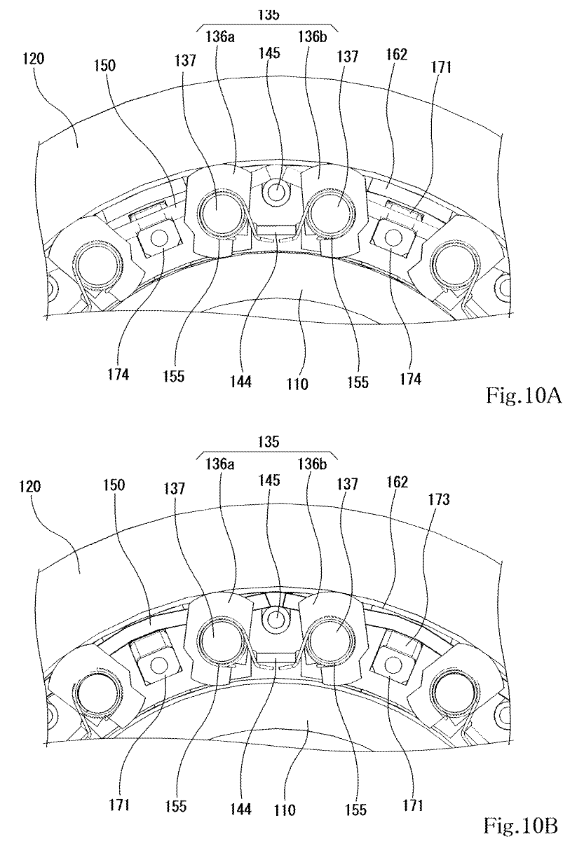

The cam orientation changing part 171 of the switching means 170 in this embodiment is formed such that a radially outer surface of the biasing force changing portion 173 extends radially inward at an angle as it extends toward one axial end (see FIG. 10B).

In the cam clutch according to the second embodiment, for example, when the switching means 170 is in the first fixing position, the first biasing means 150 is in contact with a radially outer surface of the biasing force release portion 174 of the cam orientation changing part 171 as shown in FIG. 10A, so that the biasing force of the first biasing means 150 is larger than the biasing force of the second biasing means 155. Therefore, both the first cam 136a and the second cam 136b are biased to rotate in the engaging direction so that both the first cams 136a and the second cams 136b are in sliding contact with the inner race 110 and the outer race 120, thereby being in a standby state in which one of the first cam 136a and the second cam 136b is able to immediately engage the inner race 110 and the outer race 120. Thus the operating mode of the cam clutch is the two-way lock mode that prevents relative rotation between the inner race 110 and the outer race 120 in both forward and reverse directions.

When the switching means 170 is moved from the first fixing position to the second fixing position closer to one axial end, the cam orientation changing part 171 presses the first biasing means 150 in the radially expanding direction as shown in FIG. 10B. This causes the biasing force of the first biasing means 150 to become smaller than the biasing force of the second biasing means 155, or, releases the biasing force of the first biasing means 150, thus bringing both the first cam 136a and the second cam 136b into a state of being biased to rotate in the disengaging direction. This separates the first cam 136a and the second cam 136b from the outer circumferential surface of the inner race 110, bringing them out of contact therewith. Thus the operating mode of the cam clutch 100 is switched to the two-way free mode that allows relative rotation between the inner race 110 and the outer race 120 in both forward and reverse directions.

### Third Embodiment

The cam clutch according to a third embodiment of the present invention has the same configuration as the cam clutch 100 according to the first embodiment except that a common flat spiral spring is used for the first cams 136a and the second cams 136b instead of the torsion springs as the second biasing means 155 of the cam clutch 100 according to the first embodiment.

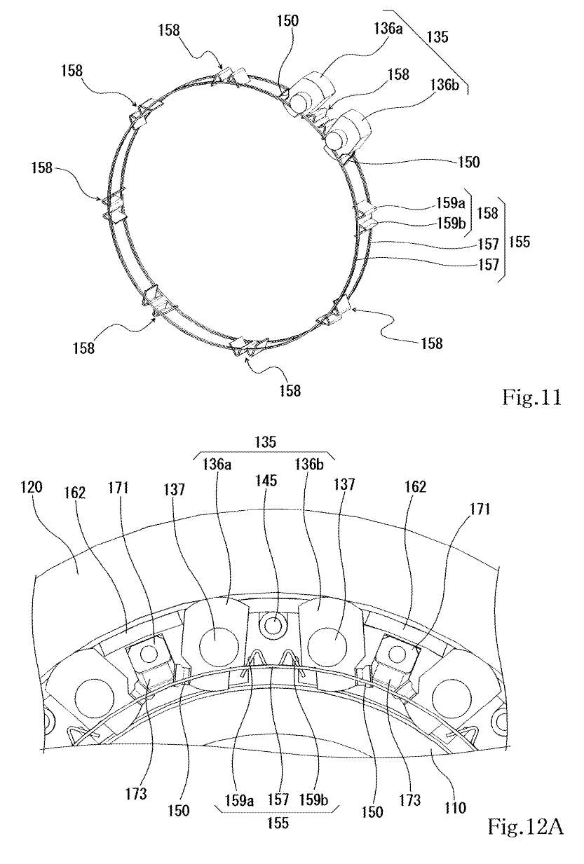

As shown in FIG. 11, the flat spiral spring as the second biasing means 155 is made up of a pair of annular parts 157 circumferentially extending parallel to each other, and a plurality of coupling parts 158 coupling the annular parts 157 in the axial direction at predetermined intervals, the coupling parts 158 each being positioned between the first cam 136a and the second cam 136b of each cam pair 135.

Each coupling part 158 includes a first plate spring portion 159a protruded radially outward to bias the first cam 136a to rotate in the disengaging direction, and a second plate spring portion 159b protruded radially outward to bias the second cam 136b to rotate in the disengaging direction.

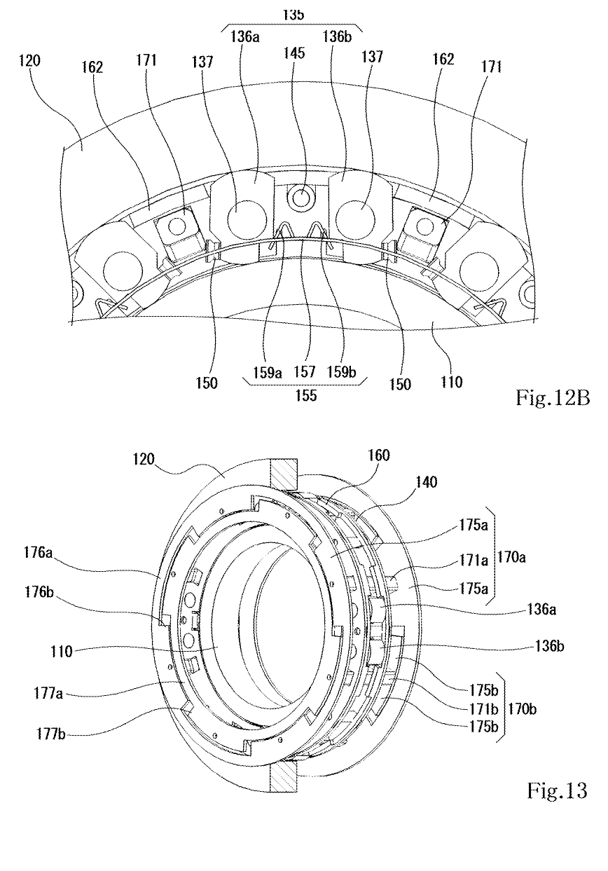

In the cam clutch according to the third embodiment, for example, when the switching means 170 is in the first fixing position, the movable end of the first biasing means 150 is in contact with the biasing force changing portion 173 of the cam orientation changing part 171 as shown in FIG. 12A, so that the biasing force of the first biasing means 150 is smaller than the biasing force of the second biasing means 155, or the biasing force of the first biasing means 150 is released. Therefore, both the first cam 136a and the second cam 136b are biased to rotate in the disengaging direction, so that both the first cam 136a and the second cam 136b are in a non-contact state separated from the outer circumferential surface of the inner race 110. Thus the operating mode of the cam clutch 100 is the two-way free mode that allows relative rotation between the inner race 110 and the outer race 120 in both forward and reverse directions.

When the switching means 170 is moved from the first fixing position to the second fixing position closer to one axial end, the cam orientation changing part 171 presses the first biasing means 150 in the compressing direction as shown in FIG. 12B. This causes the biasing force of the first biasing means 150 to become larger than the biasing force of the second biasing means 155. Namely, as the biasing force of the second biasing means 155 becomes relatively smaller than the biasing force of the first biasing means 150, the first cam 136a and the second cam 136b are biased to rotate in the engaging direction. Therefore, the first cam 136a and the second cam 136b come into sliding contact with the inner race 110 and the outer race 120, thereby being brought into a standby state in which one of the first cam 136a and the second cam 136b is able to immediately engage the inner race 110 and the outer race 120. Thus the operating mode of the cam clutch 100 is switched to the two-way lock mode that prevents relative rotation between the inner race 110 and the outer race 120 in both forward and reverse directions.

In the second embodiment and third embodiment described above, one of the first biasing means 150 and the second biasing means 155 is configured by a biasing means common to the plural cams 136. Instead, the first biasing means 150 and the second biasing means 155 may both be configured by a biasing means common to the plural cams 136. At least one of the first biasing means and the second biasing means being common to the plural cams 136 enables a reduction in the number of components, and helps avoid variation in the behavior of the cams 136.

While the present invention has been described above in two-way clutch applications, the present invention is also applicable to selectable clutches that are switchable between four operating modes including a forward lock mode and/or a reverse lock mode that prevent(s) relative rotation between the inner race and the outer race in one of the forward and reverse directions.

### Fourth Embodiment

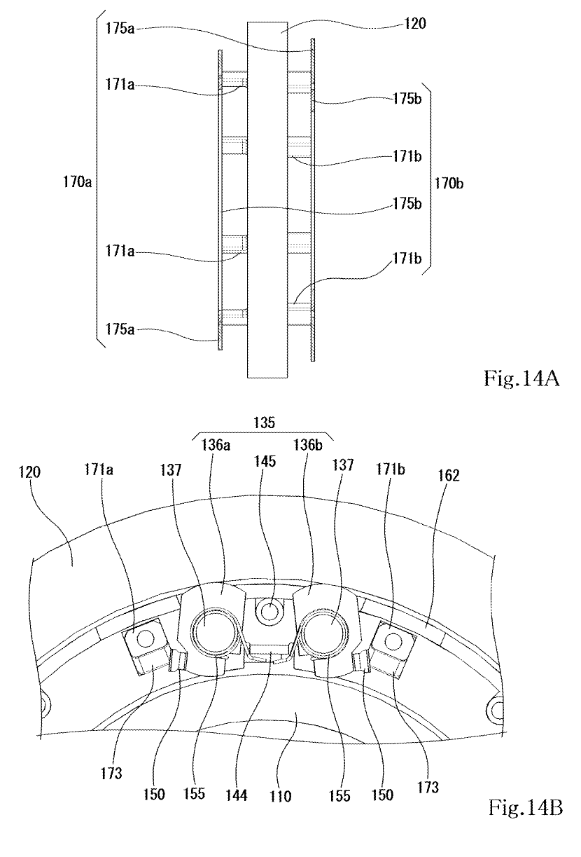

The cam clutch according to a fourth embodiment of the present invention has the same configuration as the cam clutch 100 according to the first embodiment except that the cam clutch includes a first switching means 170a that changes the biasing force of one of the first biasing means 150 and the second biasing means 155 for the first cam 136a and a second switching means 170b that changes the biasing force of one of the first biasing means 150 and the second biasing means 155 for the second cam 136b, as shown in FIG. 13.

The first switching means 170a and the second switching means 170b are provided such as to be movable independently of each other in the axial direction between a first fixing position and a second fixing position that is closer to one axial end than the first fixing position.

The first switching means 170a is made up of a plurality of axially extending columnar first cam orientation changing parts 171a disposed between the inner race 110 and the outer race 120, and a pair of substantially annular plate-like first fixing members 175a fixed to respective opposite ends of the first cam orientation changing parts 171a.

The first fixing member 175a includes an annular plate part 176a and a plurality of inwardly protruding portions 176b projecting radially inward from an inner circumferential edge of the annular plate part 176a. The inwardly protruding portions 176b are formed at predetermined circumferential intervals, with the first cam orientation changing parts 171a fixed to the respective inwardly protruding portions 176b so as to be positioned on the same circumference.

The first cam orientation changing part 171a has the same configuration as the cam orientation changing part 171 of the cam clutch 100 according to the first embodiment. Namely, in this embodiment, the first cam orientation changing part 171a is configured to change, upon axial movement of the first switching means 170a, the first biasing means 150 into a state in which the first biasing means is capable of applying a larger biasing force to the first cam 136a than a biasing force of the second biasing means 155, or, in other words, to change the biasing force of the second biasing means 155 to become smaller than the biasing force of the first biasing means 150. The first cam orientation changing parts 171a are passed through the through holes 143 of the cage ring 140 such as to be axially movable, each of them being positioned between adjacent cam pairs 135.

The second switching means 170b is made up of a plurality of axially extending columnar second cam orientation changing parts 171b disposed between the inner race 110 and the outer race 120, and a pair of substantially annular plate-like second fixing members 175b fixed to respective opposite ends of the second cam orientation changing parts 171b.

The second fixing member 175b includes an annular plate part 177a having an outer diameter sized to be fitted radially inside the first fixing member 175a, and a plurality of outwardly protruding portions 177b formed so as to project radially outward from an outer circumferential edge of the annular plate part 177a and to be fitted, with a clearance, between the inwardly protruding portions 176b of the first fixing member 175a. The outwardly protruding portions 177b are formed at predetermined circumferential intervals, with the second cam orientation changing parts 171b fixed to the respective outwardly protruding portions 177b so as to be positioned on the same circumference as the first cam orientation changing parts 171a.

In this embodiment, similarly to the first cam orientation changing part 171a, the second cam orientation changing part 171b is configured to change, upon axial movement of the second switching means 170b, the first biasing means 150 into a state in which the first biasing means is capable of applying a larger biasing force to the second cam 136b than a biasing force of the second biasing means 155, or, in other words, to change the biasing force of the second biasing means 155 to become smaller than the biasing force of the first biasing means 150. The second cam orientation changing parts 171b are passed through the through holes 143 of the cage ring 140 such as to be axially movable, each of them being positioned between adjacent cam pairs 135.

In the cam clutch according to the fourth embodiment, when the first switching means 170a and the second switching means 170b are both in the first fixing position as shown in FIG. 14A, the movable end of the first biasing means 150 for the first cam 136a and the movable end of the first biasing means 150 for the second cam 136b are respectively in contact with the biasing force changing portion 173 of the first cam orientation changing part 171a and the biasing force changing portion 173 of the second cam orientation changing part 171b as shown in FIG. 14B, so that the biasing force of the first biasing means 150 is smaller than the biasing force of the second biasing means 155, or the biasing force of the first biasing means 150 is released. Therefore, both the first cam 136a and the second cam 136b are biased to rotate in the disengaging direction, so that both the first cam 136a and the second cam 136b are in a non-contact state separated from the outer circumferential surface of the inner race 110. Thus the operating mode of the cam clutch is the two-way free mode that allows relative rotation between the inner race 110 and the outer race 120 in both forward and reverse directions.

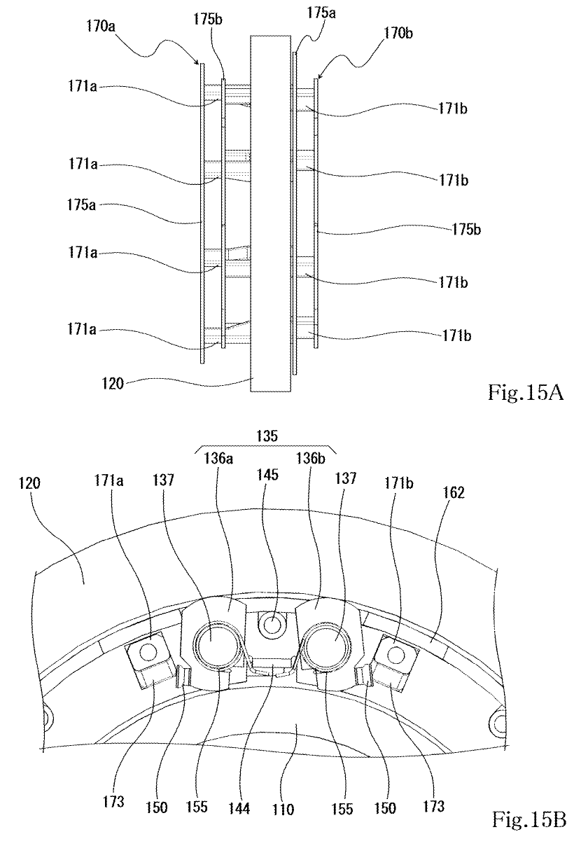

When the first switching means 170a alone is moved from the first fixing position to the second fixing position closer to one axial end as shown in FIG. 15A, the first cam orientation changing part 171a presses the first biasing means 150 for the first cam 136a in the compressing direction as shown in FIG. 15B. This causes the biasing force of the first biasing means 150 to become larger than the biasing force of the second biasing means 155. Namely, as the biasing force of the second biasing means 155 becomes relatively smaller than the biasing force of the first biasing means 150, the first cam 136a is biased to rotate in the engaging direction. Therefore, the first cam 136a comes into sliding contact with the inner race 110 and the outer race 120, thereby being brought into a standby state in which the first cam 136a is able to immediately engage the inner race 110 and the outer race 120 when the inner race 110 is rotated in the forward direction (clockwise direction in FIG. 15B) or when the outer race 120 is rotated in the reverse direction (counterclockwise in FIG. 15B). Thus the operating mode of the cam clutch is switched to the forward lock mode that prevents relative rotation between the inner race 110 and the outer race 120 in the forward direction.

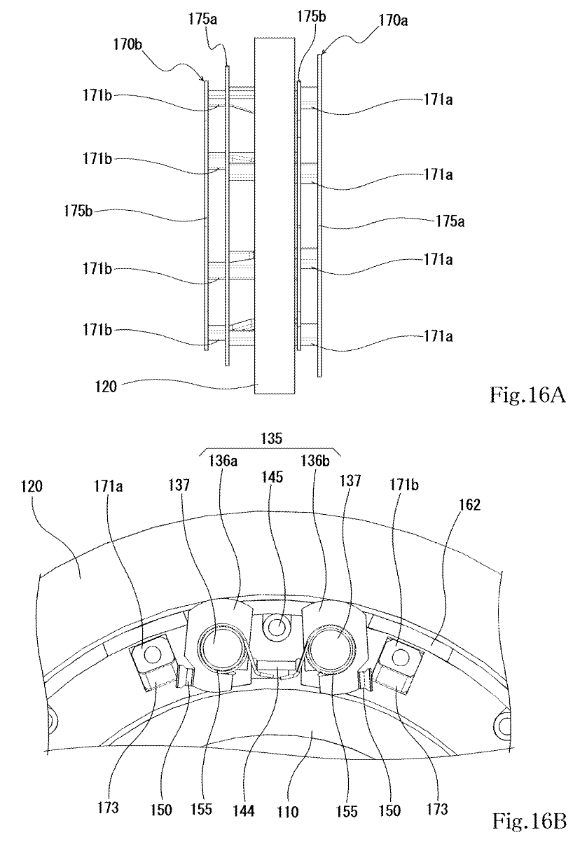

When the second switching means 170b alone is moved from the first fixing position to the second fixing position closer to one axial end as shown in FIG. 16A, the second cam orientation changing part 171b presses the first biasing means 150 for the second cam 136b in the compressing direction as shown in FIG. 16B. This causes the biasing force of the first biasing means 150 to become larger than the biasing force of the second biasing means 155. Namely, as the biasing force of the second biasing means 155 becomes relatively smaller than the biasing force of the first biasing means 150, the second cam 136b is biased to rotate in the engaging direction. Therefore, the second cam 136b comes into sliding contact with the inner race 110 and the outer race 120, thereby being brought into a standby state in which the second cam 136b is able to immediately engage the inner race 110 and the outer race 120 when the inner race 110 is rotated in the reverse direction (counterclockwise direction in FIG. 16B) or when the outer race 120 is rotated in the forward direction (clockwise in FIG. 16B). Thus the operating mode of the cam clutch is switched to the reverse lock mode that prevents relative rotation between the inner race 110 and the outer race 120 in the reverse direction.

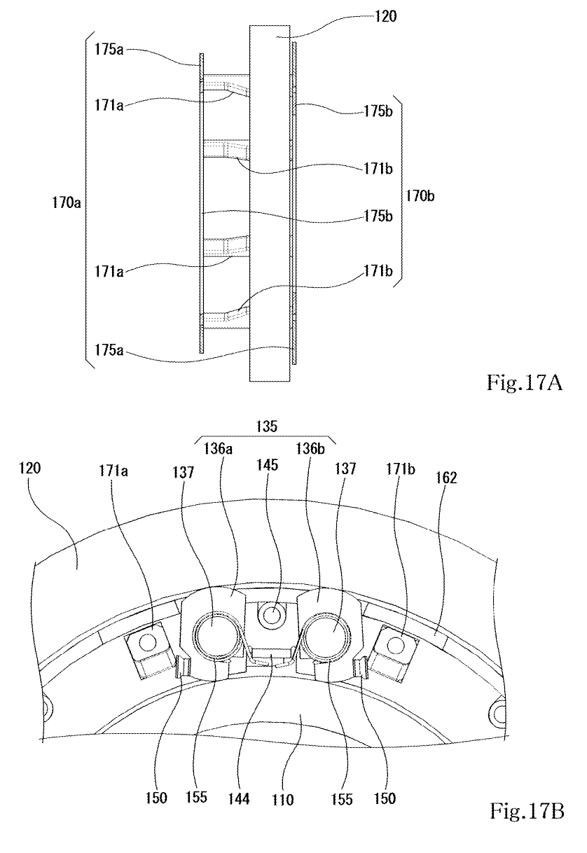

When the first switching means 170a and the second switching means 170b are moved together from the first fixing position to the second fixing position closer to one axial end as shown in FIG. 17A, the biasing force of the first biasing means 150 becomes larger than the biasing force of the second biasing means 155. Namely, as the biasing force of the second biasing means 155 becomes relatively smaller than the biasing force of the first biasing means 150, the first cam 136a and the second cam 136b are biased to rotate in the engaging direction as shown in FIG. 17B. Therefore, the first cam 136a and the second cam 136b come into sliding contact with the inner race 110 and the outer race 120, thereby being brought into a standby state in which one of the first cam 136a and the second cam 136b is able to immediately engage the inner race 110 and the outer race 120. Thus the operating mode of the cam clutch is switched to the two-way lock mode that prevents relative rotation between the inner race 110 and the outer race 120 in both forward and reverse directions.

As described above, the cam clutch is switchable between four operating modes by selectively rotating one or both of the first cam 136a and the second cam 136b: A two-way lock mode in which torque is transmissible in both forward and reverse directions; a forward lock mode in which torque is transmissible in the forward direction; a reverse lock mode in which torque is transmissible in the reverse direction; and a two-way free mode in which the clutch freewheels in both forward and reverse directions.

### Fifth Embodiment

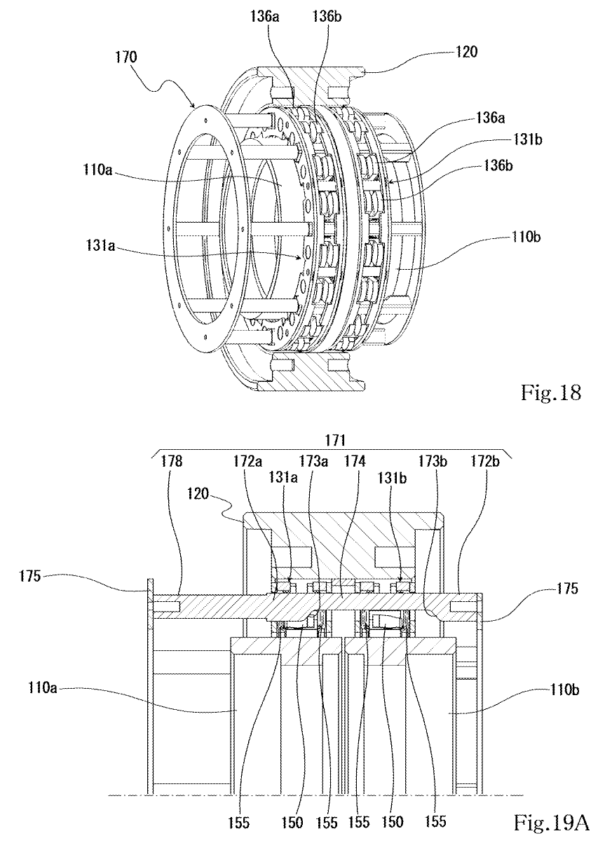

The cam clutch according to a fifth embodiment of the present invention includes a first cam mechanism 131a and a second cam mechanism 131b as shown in FIG. 18. The first cam mechanism 131a switches the operating mode to the two-way lock mode in which torque is transmitted between the inner race and the outer race, while the second cam mechanism 131b switches the operating mode to the two-way lock mode in which torque is transmitted between the inner race and the outer race and the two-way free mode in which torque transmission is stopped in both forward and reverse directions.

In the cam clutch of this embodiment, a first inner race 110a and a second inner race 110b having an identical configuration are juxtaposed in the axial direction, and an outer race 120 is coaxially disposed so as to be relatively rotatable with the first inner race 110a and the second inner race 110b. The first cam mechanism 131a is disposed between the first inner race 110a and the outer race 120, and the second cam mechanism 131b is disposed between the second inner race 110b and the outer race 120.

Although not shown, in an alternative configuration, a first outer race and a second outer race having an identical configuration may be juxtaposed in the axial direction, and an inner race may be coaxially disposed so as to be relatively rotatable with the first outer race and the second outer race, with the first cam mechanism and the second cam mechanism being respectively disposed between the inner race and the first outer race and between the inner race and the second outer race.

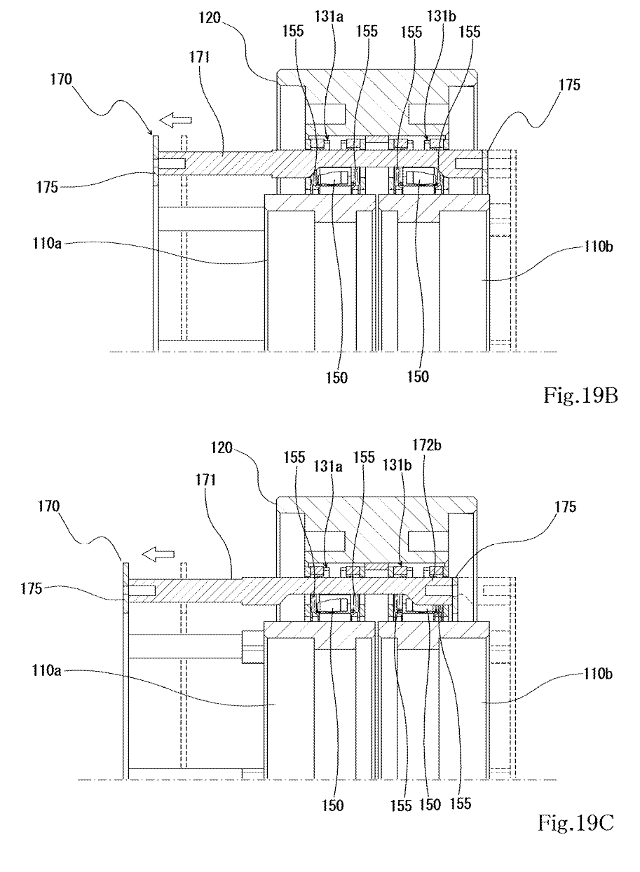

The first cam mechanism 131a and the second cam mechanism 131b have the same configuration as the cam mechanism 130 of the cam clutch 100 according to the first embodiment. As shown in FIG. 19A, plate springs as the first biasing means 150 are disposed to be convex axially outward in the first cam mechanism 131a and the second cam mechanism 131b.

The cam orientation changing part 171 of the switching means 170 in this embodiment includes a biasing force application portion on one end 172a, a first biasing force changing portion 173a continuous with the other axial end of the biasing force application portion on one end 172a, a biasing force release portion 174 continuous with the other axial end of the first biasing force changing portion 173a, a second biasing force changing portion 173b continuous with the other axial end of the biasing force release portion 174, and a biasing force application portion on the other end 172b continuous with the other axial end of the second biasing force changing portion 173b. The biasing force application portion on one end 172a and the biasing force application portion on the other end 172b are prismatic and have the same radial dimension. The biasing force release portion 174 is prismatic and has a smaller radial dimension than the biasing force application portion on one end 172a and the biasing force application portion on the other end 172b. The first biasing force changing portion 173a is formed such that its radially inner surface extends radially outward at an angle as it extends toward the other axial end. The second biasing force changing portion 173b is formed such that its radially inner surface extends radially inward at an angle as it extends toward the other axial end. Reference numeral 178 in FIG. 19A denotes a columnar extension for fixing the cam orientation changing part 171 to the fixing member 175 on one axial end.

In the cam clutch according to the fifth embodiment, for example, when the switching means 170 is in the first fixing position, the first biasing means 150 of the first cam mechanism 131a is in contact with an outer surface of the biasing force application portion on one end 172a of the cam orientation changing part 171 as shown in FIG. 19A, so that the biasing force of the first biasing means 150 is larger than the biasing force of the second biasing means 155. Therefore, both the first cam 136a and the second cam 136b in the first cam mechanism 131a are biased to rotate in the engaging direction so that both the first cam 136a and the second cam 136b are in sliding contact with the first inner race 110a and the outer race 120, thereby being in a standby state in which one of the first cam 136a and the second cam 136b is able to immediately engage the first inner race 110a and the outer race 120.

The first biasing means 150 in the second cam mechanism 131b meanwhile is not in contact with the cam orientation changing part 171 so that the biasing force of the first biasing means 150 is released. This causes both the first cam 136a and the second cam 136b in the second cam mechanism 131b to be biased to rotate in the disengaging direction, so that both the first cam 136a and the second cam 136b are in a non-contact state separated from the outer circumferential surface of the second inner race 110b.

Thus the operating mode of the cam clutch is the two-way lock mode that prevents relative rotation between the first inner race 110a and the outer race 120 in both forward and reverse directions.

When the switching means 170 is moved from the first fixing position to the second fixing position closer to one axial end, all the first biasing means 150 in the first cam mechanism 131a and the second cam mechanism 131b come out of contact with the cam orientation changing parts 171 as shown in FIG. 19B, so that the biasing force of the biasing means 150 is released. This causes both the first cams 136a and the second cams 136b in the first cam mechanism 131a and the second cam mechanism 131b to be biased to rotate in the disengaging direction, so that the first cams 136a and the second cams 136b are brought into a non-contact state separated from the outer circumferential surface of the first inner race 110a and the second inner race 110b.

Thus the operating mode of the cam clutch is switched to the two-way free mode that allows relative rotation between the first inner race 110a and the outer race 120, and relative rotation between the second inner race 110b and the outer race 120, in both forward and reverse directions.

When the switching means 170 is moved from the first fixing position to a third fixing position even closer to one axial end than the second fixing position, the first biasing means 150 in the first cam mechanism 131a come out of contact with the cam orientation changing parts 171 as shown in FIG. 19C, so that the biasing force of the biasing means 150 is released. This causes both the first cam 136a and the second cam 136b in the first cam mechanism 131a to be biased to rotate in the disengaging direction, so that the first cam 136a and the second cam 136b are brought into a non-contact state separated from the outer circumferential surface of the first inner race 110a.

Meanwhile, the first biasing means 150 in the second cam mechanism 131b come into contact with an outer surface of the biasing force application portion on the other end 172b of the cam orientation changing parts 171, bringing about a state in which the biasing force of the first biasing means 150 is larger than the biasing force of the second biasing means 155, i.e., the biasing force of the second biasing means 155 is relatively smaller than the biasing force of the first biasing means 150. Therefore, both the first cam 136a and the second cam 136b in the second cam mechanism 131b are biased to rotate in the engaging direction so that both the first cam 136a and the second cam 136b come into sliding contact with the second inner race 110b and the outer race 120, thereby being brought into a standby state in which one of the first cam 136a and the second cam 136b is able to immediately engage the second inner race 110b and the outer race 120.

Thus the operating mode of the cam clutch is switched to the two-way lock mode that prevents relative rotation between the second inner race 110b and the outer race 120 in both forward and reverse directions.

While embodiments of the present invention have been described in detail, the present invention is not limited to the above-described embodiments and may be carried out with various design changes without departing from the scope of the present invention set forth in the claims.

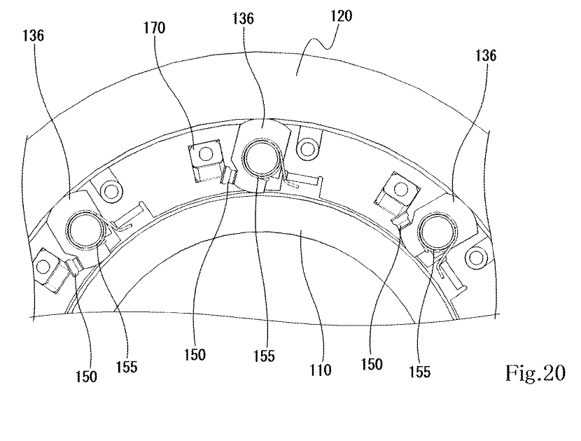

For example, the cam clutch according to the embodiments described above uses two types of cams, a first cam and a second cam having different engaging directions. Instead, only one type of cam 136 may be used as shown in FIG. 20. In this cam clutch, for example, when the switching means 170 is in the first fixing position, the biasing force of the first biasing means 150 is smaller than the biasing force of the second biasing means 155 or the biasing force of the first biasing means 150 is released, so that the cams 136 are in a non-contact state separated from the outer circumferential surface of the inner race 110. Axially moving the switching means 170 from the first fixing position to the second fixing position closer to one axial end changes the biasing force of the first biasing means 150 to become larger than the biasing force of the second biasing means 155, or, in other words, changes the biasing force of the second biasing means 155 to become relatively smaller than the biasing force of the first biasing means 150. This brings the cams 136 into a standby state in which they are able to immediately engage the inner race 110 and the outer race 120. The present invention can be applied to a one-way clutch in this way to allow the clutch to function as a selectable clutch that can operate in a two-way free mode.

While some of the illustrated embodiments do not include a link member, these embodiments may also adopt a configuration with a link member that links the rotational motions of all the cams. Such a configuration will enable stable operation to be achieved without variation among the respective rotational motions of the plurality of cams.

### Reference Signs List

100 Cam clutch

110 Inner race

110a First inner race

110b Second inner race

120 Outer race

130 Cam mechanism

131a First cam mechanism

131b Second cam mechanism

135 Cam pair

136 Cam

136a First cam

136b Second cam

137 Rotating shaft portion

138 Mounting groove

139a Notched portion

139b Stepped portion

140 Cage ring

141 Annular plate member

142 Retaining hole

143 Through hole

144 Second biasing means support portion

145 Spacer member

150 First biasing means

155 Second biasing means

156a Coil portion

156b Coupling portion

157 Annular part

158 Coupling part

159a First plate spring portion

159b Second plate spring portion

160 Cam link member

161 Base part

162 Pawl portion

170 Switching means

170a First switching means

170b Second switching means

171 Cam orientation changing part

171a First cam orientation changing part

171b Second cam orientation changing part

172 Biasing force application portion

172a Biasing force application portion on one end

172b Biasing force application portion on the other end

173 Biasing force changing portion

173a First biasing force changing portion

173b Second biasing force changing portion

174 Biasing force release portion

175 Fixing member

175a First fixing member

175b Second fixing member

176a Annular plate part

176b Inwardly protruding portion

177a Annular plate part

177b Outwardly protruding portion

178 Extension

1. A cam clutch comprising: an inner race and an outer race coaxially disposed and rotatable relative to each other; a plurality of cams disposed between the inner race and the outer race; a first biasing means that biases the cams to rotate in an engaging direction; and a switching means configured to forcibly rotate the cams to allow switching of operating modes,
the cam clutch further comprising a second biasing means that biases the cams to rotate in a disengaging direction, with a biasing force that is different from a biasing force applied by the first biasing means,
the switching means including a cam orientation changing part configured to change a larger one of biasing forces applied to the same cam by the first biasing means and the second biasing means to become relatively smaller than the other of the biasing forces.

2. The cam clutch according to claim 1, further comprising a cam link member that links rotational motions of all the cams.

3. The cam clutch according to claim 2, wherein the cams include a first cam and a second cam that each have a different engaging direction, and
the cam link member is configured such that, when one of the first cam and the second cam rotates in an engaging direction, the cam link member causes the other cam to rotate in a disengaging direction.

4. The cam clutch according to claim 1, wherein the switching means is provided in a manner axially movable, with the cam orientation changing part being positioned between adjacent cams, and
the cam orientation changing part is configured to change a biasing force applied to the cams by the first biasing means upon axial movement of the switching means.

5. The cam clutch according to claim 4, wherein the biasing force of the first biasing means applied to the same cam is smaller than the biasing force of the second biasing means applied to the same cam, and
the cam orientation changing part is configured to change the first biasing means into a state in which the first biasing means is capable of applying a biasing force larger than the biasing force of the second biasing means.

6. The cam clutch according to claim 4, wherein the biasing force of the first biasing means applied to the same cam is larger than the biasing force of the second biasing means applied to the same cam, and
the cam orientation changing part is configured to change the first biasing means into a state in which the first biasing means is capable of applying a biasing force smaller than the biasing force of the second biasing means, or a state in which the first biasing means releases the biasing force applied to the cams.

7. The cam clutch according to claim 1, wherein at least one of the first biasing means and the second biasing means is common to the plurality of cams.

8. The cam clutch according to claim 3, wherein the switching means includes a first switching means that changes a biasing force of one of the first biasing means and the second biasing means, applied to the first cam, and a second switching means that changes a biasing force of one of the first biasing means and the second biasing means, applied to the second cam.
